(19) United States
(12) Patent Application Publication
(10) Pub. No.: US 2006/0085324 A1
(43) Pub. Date: Apr. 20, 2006

(54) Municipal bond offer and method

(75) Inventor: Mark Laubacher, Western Springs, IL (US)

Correspondence Address: SCHIFF HARDIN LLP;Patent Department, 6600 Sears Tower, 233 South Wacker Drive, Chicago, IL, 60606, US

(73) Assignee: The Laubacher Company

(21) Appl. No.: 10/965,986

(22) Filed: Oct. 15, 2004

(51) Int. Cl. G06Q 40/00

(52) U.S. Cl. 705/38

(57) ABSTRACT

A system and method for providing municipal bonds secured by GNMA securities for multifamily development projects, includes securing a commitment from the bond purchaser at the initiation of the transaction for periodic purchases of portions of the bonds over the period of the construction or rehabilitation of the development project, which bonds will pay a fixed interest rate. As each stage of construction is carried out and the expenses therefore incurred and loan advances are made, applications are made for approval to issue corresponding GNMA securities. Once issuance of the GNMA securities is approved, municipal bonds are issued to acquire such GNMA securities and such municipal bonds are purchased by the bond purchaser at the agreed upon fixed interest rate.

### BACKGROUND OF THE INVENTION

1. Field of the Invention

The present invention relates generally to a method and system for the sale of municipal bonds.

2. Description of the Related Art

Sales of municipal bonds are utilized to finance building projects. For example, bond financing is an important source of funds for the development of affordable housing. States, cities, counties and their housing and redevelopment authorities utilize bond financing to construct and rehabilitate housing for low and moderate income families. One example of such a building project is a multifamily housing project. Building projects are frequently financed by issuance of bonds through a state or local unit of government, such as a city or town. Such municipal issued bonds can be tax exempt so that the interest on the bond being paid to the bond purchaser is non-taxable.

A bond is a certificate of debt that usually is interest bearing and is issued by a government or corporation in order to raise money. The issuer of the bond is usually required to pay a specified amount periodically until maturity of the bond.

Purchasers of bonds seek assurance that the bond will be repaid on the specific dates with the agreed upon interest. One way to provide such assurance is to secure third party credit enhancement to strengthen the likelihood of timely payment of the bonds.

One form of credit enhancement available for municipal bonds that finance multifamily housing developments is mortgage-backed securities (MBS) guaranteed by the Government National Mortgage Association (GNMA). Securities guaranteed by GNMA are also guaranteed by the federal government.

There are several participants in an issuance of municipal bonds that are secured by mortgage-backed securities guaranteed by GNMA: GNMA, a municipal bond issuer, and its trustee, a project borrower, private sector lender that typically also performs as issuer of the GNMA securities.

GNMA is a wholly-owned corporate instrumentality of the United States of America within the Department of Housing and Urban Development. Timely payment of principal of and interest on GNMA securities is guaranteed GNMA pursuant to Section 306(g) of the National Housing A of 1934, as amended (the “National Housing Act). Section 306(g) provides that “the full faith and credit of the United States is pledged to the payment of all amounts which may be require to be paid under any guaranty under this subsection.” An opinion, dated Dec. 9, 1969, of William H. Rehnquist, Assistant Attorney General of the United States, states that such guaranties under Section 306(g) of mortgage-backed securities of the type offered hereby are authorized to be made by GNMA and “would constitute general obligations of the United States backed by its full faith arid credit.”

GNMA guarantees investors the timely payment of principal and interest on MBS that represent the underlying interests of federally insured or guaranteed loans.

There are several stringent conditions for the issuance of GNMA multifamily securities. The principal condition is that the loan underlying the GNMA multifamily security be insured by either the Federal Housing Administration (FHA) (a unit of the U.S. Department of housing and Urban Development), guaranteed by the U.S. Department of Veterans Affairs or insured or guaranteed by the Department of Agriculture Rural Housing Service.

There are also several stringent requirements for securing FHA mortgage insurance for multifamily developments. A key requirement is that the lender making the loan provides a fixed rate for the entire permanent loan term. The permanent loan term for a FHA-insured multifamily loan is typically 30-40 years. Typically, the FHA lender will arrange for a third party investor to make a corresponding commitment to provide capital at a fixed rate so the lender may satisfy its obligations to provide a fixed rate FHA-insured loan. A common method for an FHA lender to attract such investor capital is for the FHA lender to issue GNMA multifamily securities.

GNMA multifamily securities are issued and available for purchase only after the borrower's development proceeds through its construction phases and proper approval for loan advances for each such construction phase is approved by the government guarantor. In most cases there is a construction period in which loan advances are released periodically. So the FHA lender can satisfy its requirements, the purchaser of the GNMA securities commits at the initiation of the process to purchase GNMA Securities bearing an agreed upon fixed rate for the entire development phase. The investor takes delivery of the fixed rate GNMA securities as the construction costs for the project are incurred and loan advances approved by the government guarantor such as FHA.

Borrowers can incur a substantial additional “negative arbitrage” cost when using tax-exempt bond financing for apartment building multifamily properties. Although generally expenditures to pay construction costs occur once a month, for the typical municipal bond issue, 100% of the tax-exempt bond proceeds are borrowed at once before the beginning of construction. Thus, unspent bond proceeds are invested in short term instruments pending progress on the construction of the development.

The borrowing cost of the long-term, fixed rate municipal bonds is often higher than the achievable reinvestment rate on the unspent proceeds of the municipal bonds issue. For instance, as of the 3rd quarter of 2004, the borrowing rate for municipal bonds issued to purchase GNMA multifamily securities was in the range of 5.00-5.50% per annum. The reinvestment rate on unspent proceeds of the municipal bonds was in the range of 0.75-1.50% per annum. Thus, until the multifamily GNMA multifamily securities are available for purchase, the unspent proceeds of the municipal issue are locked in at a guaranteed loss of roughly 4.0% per annum. The industry term for this locked-in, guaranteed loss is “negative arbitrage”.

The money lost by the effects of negative arbitrage must be covered by the borrower, and so represents an additional cost of borrowing the money. The negative arbitrage, or shortfall, must be covered by setting aside additional funds in the borrower's project budget.

### SUMMARY OF THE INVENTION

The present invention eliminates the expense resulting from negative arbitrage in a municipal bond issue, the proceeds of which are used to acquire GNMA securities and eliminates the need to finance the project to an extent to cover the cost of the negative arbitrage. According to the present invention, a sale of municipal bonds, the proceeds of which are used to acquire GNMA securities, is structured for an incremental draw down over the life of the construction project while providing for a commitment from the bond purchaser to purchase the on a forward delivery basis municipal bonds bearing a fixed interest rate.

In particular, instead of funding the entire face value of the municipal bonds at the time of initial closing, the municipal bonds are sold, funded and purchased, in incremental amounts corresponding to the periodic issuance GNMA multifamily securities which represent advances of the underlying construction loan.

The present structured bond sale results in a substantial reduction in the net cost to a borrower for the issuance of tax exempt municipal securities, specifically for those in a multifamily GNMA guaranteed building project.

### BRIEF DESCRIPTION OF THE DRAWINGS

FIG. 1 is a block diagram of the key participants involved in a municipal bond issue to finance a multifamily development;

FIG. 2 is a flow diagram of the process of a conventional loan for a construction of a multifamily housing development;

FIGS. 3a and 3b are a flow diagram of the financing for construction of a housing development with a loan insured by FHA and funded by the sale of GNMA securities;

FIGS. 4a and 4b are a flow diagram of the financing for construction of a housing development loan insured by FHA and funded by the sale of GNMA securities to a tax exempt bond issuer; and

FIGS. 5a and 5b are a flow diagram of a bond issue according to the principles of the present invention including incremental drawdown of the bonds.

### DETAILED DESCRIPTION OF THE PREFERRED EMBODIMENTS

In the present invention, a method and structure for issuing tax exempt municipal bonds which are used to purchase GNMA multifamily securities is provided. The tax exempt municipal bonds are sold on an incremental, forward delivery basis for a period exceeding 90 days from the initial issuance of the bonds. The bonds bear a fixed rate of interest, and a preferred embodiment, have a maturity of more than 20 years. The result of the present bond issue structure is a substantial reduction in the net cost to the borrower.

The present bond structure complies with government regulations that enable the acquisition of GNMA securities with the proceeds of a municipal bond issue.

Here, forward delivery means issuance, delivery and purchase of bonds on future dates that are beyond the standard settlement dates. Draw down bonds are bonds that are issued incrementally on a forward delivery basis, a portion at a time.

Typically, an FHA Lender and GNMA Issuer are either (a) two departments of one firm or (b) two firms performing in a cooperating correspondent relationship. Here, we use the term “FHA Lender/GNMA Issuer” to indicate the parties in either the FHA Lender role, the GNMA issuer role or both. For ease of reading, the terms “FHA Lender” or “GNMA Issuer” are sometimes used by themselves when the context relates to a specific role in the process.

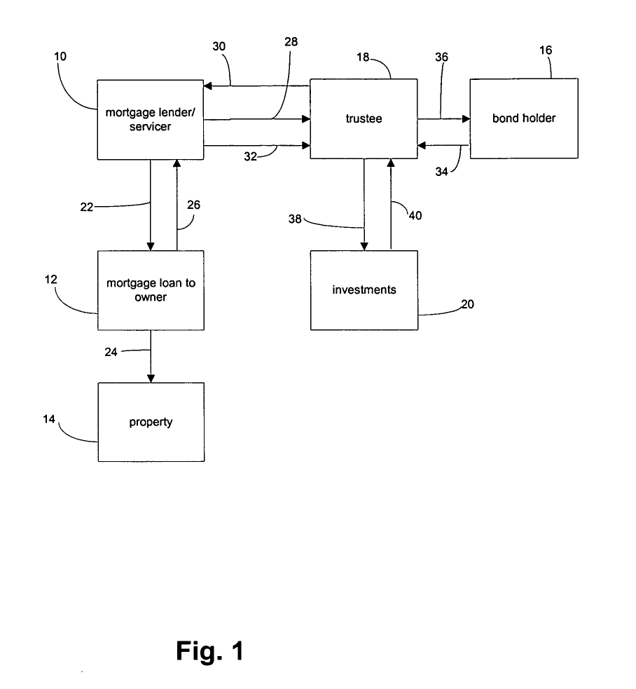

With reference to the drawings, FIG. 1 shows that there are five key participants in a municipal bonds issue the proceeds of which are used to purchase GNMA multifamily securities. A FHA Lender/GNMA Issuer 10 makes a loan to a property developer 12, then executes various documents to have the repayment of such loan advances guaranteed by GNMA, which then permits the FHA Lender/GNMA Issuer 10 to issue multifamily GNMA securities representing interests in the underlying loan. The borrower/property developer 12 uses the loan advance to build an apartment property 14. A bond purchaser 16 purchases and holds the municipal bonds. A bond trustee 18 hold the proceeds of the sale of the municipal bonds and applies it to purchase GNMA securities as they are made available by the FHA Lender/GNMA Issuer 10. The trustee 18 makes investments 20 of the unspent bond proceeds, the interest on which are paid to the bond trustee 18 that contribute to the payment of debt service to the bond investor 16.

In particular, the transactions between the parties include: the FHA Lender/GNMA Issuer 10 provides construction advances 22 on the mortgage loan to the owner 12, who then pays the costs for the construction 24 on the property 14. The FHA Lender/GNMA Issuer 10 delivers the GNMA guaranteed mortgage backed securities 28 to the trustee 18. The bond holder 16 pays cash 34 to the trustee 18 to purchase the municipal bonds. The trustee 18 pays cash to the FHA Lender/GNMA Issuer 10 to purchase the GNMA securities 30. This payment 30 replenishes the capital the FHA Lender/GNMA Issuer 10 originally provided to make construction advances 22.

The trustee 18 also invests the undistributed bond proceeds 38 into the investments 20 and receives in turn earnings 40 that contribute to payment of the debt service 36 on the municipal bonds.

The owner 12 makes monthly mortgage payments 26 to the FHA Lender/GNMA Issuer 10. Each month, the FHA Lender/GNMA Issuer 10 takes the owner's mortgage payment 26 then makes a pass-through of this payment to the holder of the GNMA securities 32, the trustee 18. Periodically, the trustee makes payments of principal and interest 36 on the municipal bonds to the bond holder 16.

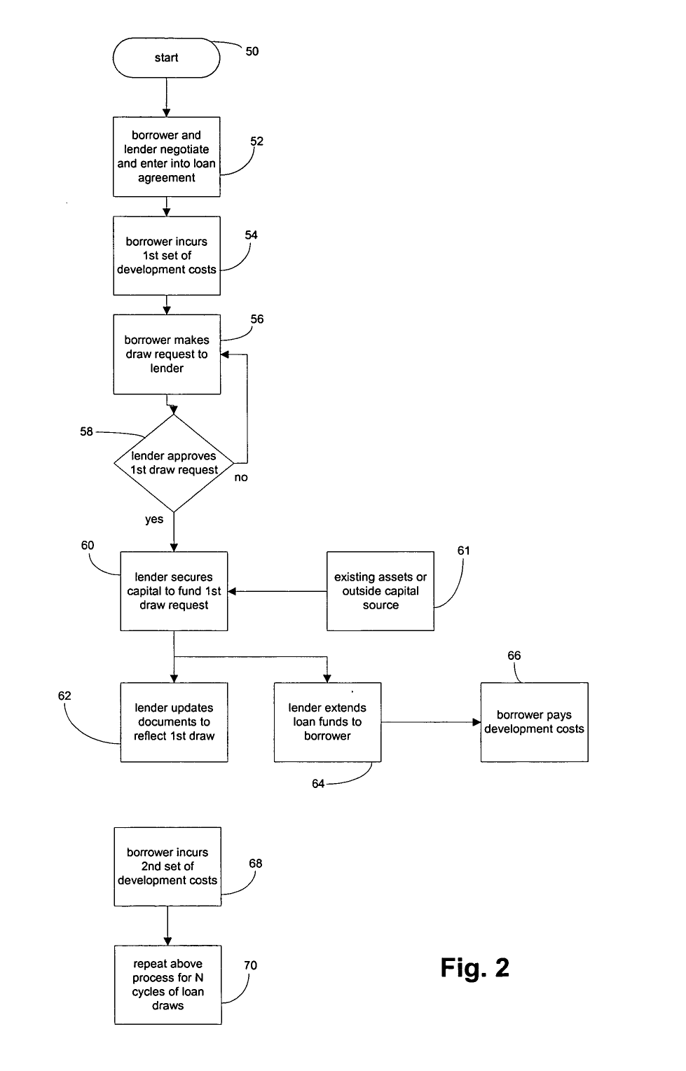

In FIG. 2, the standard conventional loan for construction of an apartment building development is shown. The process starts at 50. The borrower and lender negotiate and enter into a loan agreement 52. This is the loan negotiation process between the borrower and lender. Next, the borrower incurs the first set of development costs 54 in the construction or remodeling of the apartment building. The borrower makes a draw request 56 to the lender and, if the lender approves the draw request 58, the lender applies or secures capital 61 to fund the first draw request 60. The capital comes from existing assets or an outside capital source. If the lender does not approve the draw request 58, then the disapproval is returned to the borrower to correct the draw request 56. Once the lender has secured the capital to fund the draw request, the lender updates the documents to reflect the draw request 62. The lender also extends the loan funds to the borrower 64. The borrower then pays the development costs 66. This completes the first draw on the loan. When a second set of development costs are incurred 68, the borrower again makes a draw request to the lender and seeks approval so that the requesting and approval steps 54 through 66 are repeated for “n” cycles of loan draws 70.

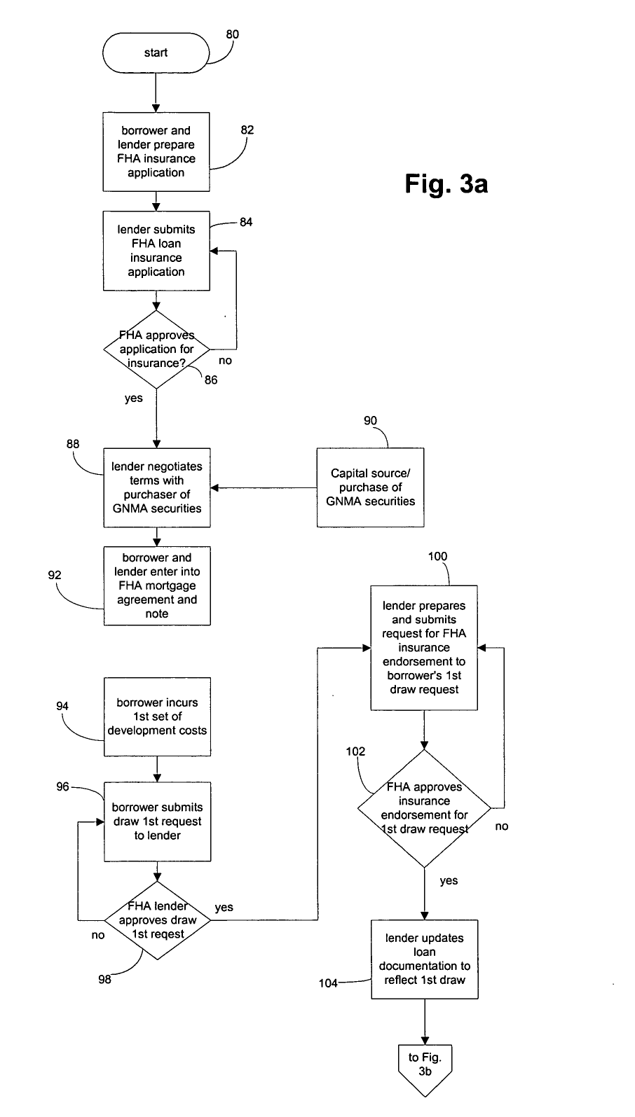

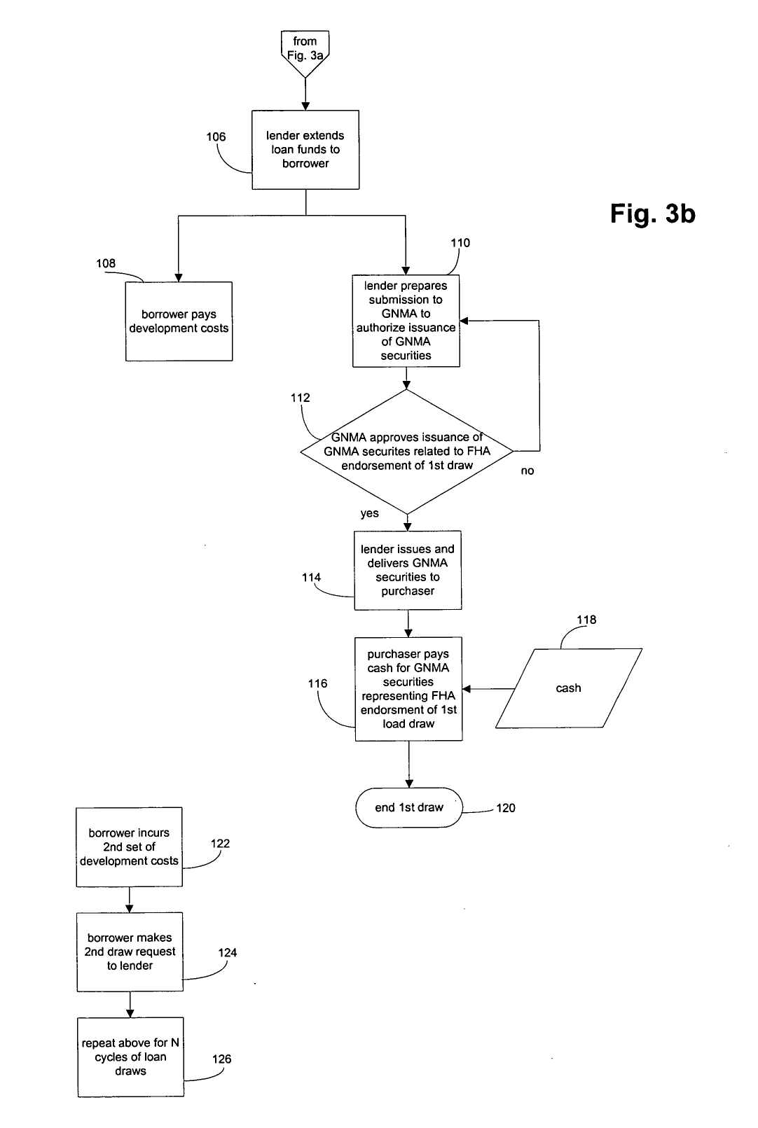

Turning now to FIG. 3a, the process of financing the construction of an apartment loan insured by FHA and funded by sales of GNMA securities is shown. The process starts at 80 and the borrower and FHA Lender prepare an FHA insurance application 82. The FHA Lender submits the FHA loan insurance application 84. If the FHA approves the application for insurance 86, the FHA Lender/GNMA Issuer negotiates terms with a purchaser of GNMA securities 88. This negotiation is carried out with the purchaser of GNMA securities as the capital source 90. To complete the process for loan negotiations, the borrower and FHA Lender/GNMA Issuer enter into an FHA mortgage agreement and note 92. It is possible to reverse the steps 88 and 92.

Following the negotiation of the loan, the process begins for periodic draws on the loan. This is initiated by the borrower incurring a first set of development costs 94 after which the borrower submits a first draw request to the FHA Lender/GNMA Issuer 96. If the FHA Lender/GNMA Issuer approves the draw request 98 then the FHA Lender/GNMA Issuer prepares and submits the request for FHA insurance endorsements 100 of the borrower's first loan draw request. If the request is refused, it is returned to the borrower 96 to resubmit until approved. Once the FHA Lender/GNMA Issuer has requested FHA insurance 100, the FHA may approve the insurance endorsement for the first draw request at 102. If the FHA does not approve the insurance endorsement, it is returned to the FHA Lender/GNMA Issuer at 100 to correct the request. Following FHA approval 102, the FHA Lender/GNMA Issuer updates the loan documentation to reflect the first draw 104.

After updating the loan documents to reflect the first draw 104, as shown in FIG. 3b, the FHA Lender/GNMA Issuer extends the loan funds to the borrower 106. The borrower then pays the development costs 108 and the FHA Lender/GNMA Issuer prepares a submission to GNMA to authorize issuance of GNMA securities 110. If GNMA approves the issuance of GNMA securities related to the FHA endorsement of the first draw 112, then the FHA Lender/GNMA Issuer issues the GNMA securities and delivers the GNMA securities to the purchaser 114 pursuant to the terms of the agreement made at step 88. If GNMA does not approve the issuance of the securities, the submission is returned to the FHA Lender/GNMA Issuer at 110 for correction. Following the delivery of the GNMA securities 114, the purchaser pays cash to the FHA Lender/GNMA Issuer for the GNMA securities 116. This completes the end of the first draw 120.

With further reference to FIG. 3b, the borrower incurs a second set of development costs 122 after which the borrower submits a second draw request to the FHA Lender/GNMA Issuer 124 and the cycle of steps 94 to 120 is repeated “N” times, once for each loan draw 126.

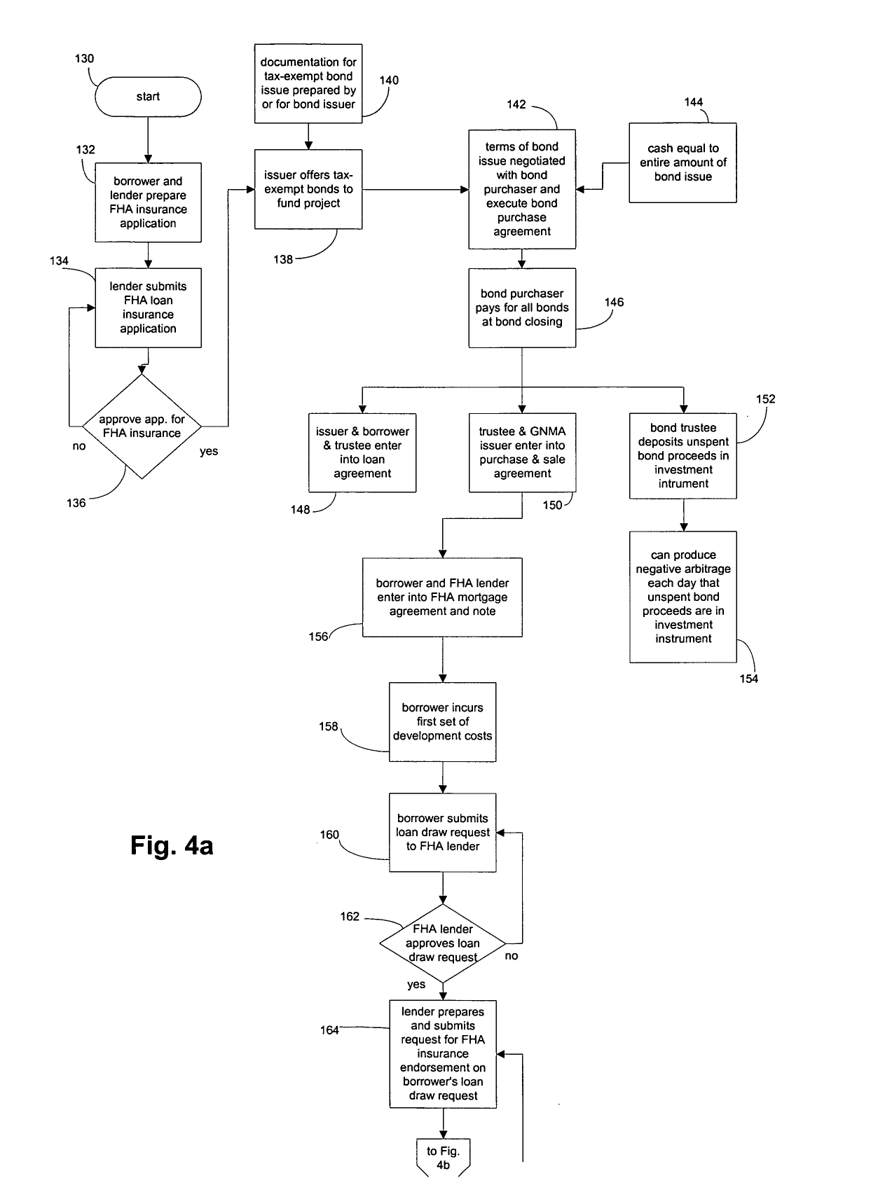

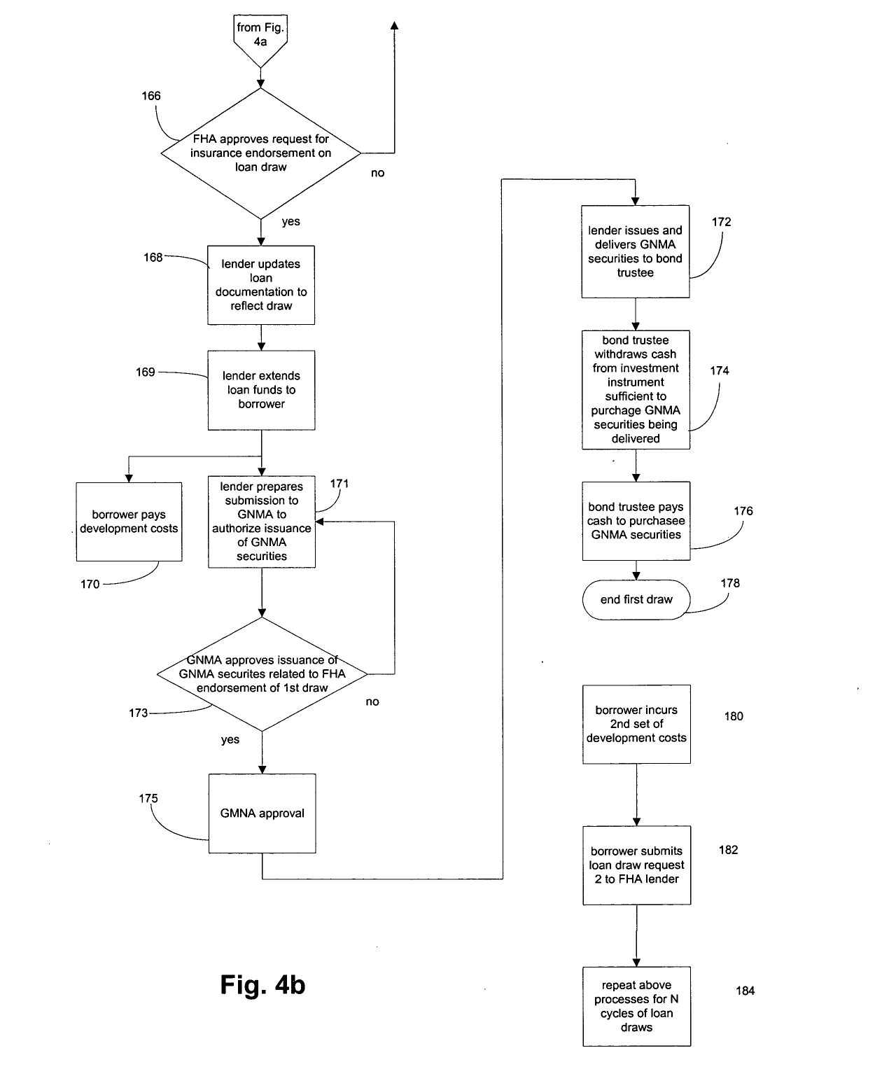

FIGS. 4a and 4b show the process of a tax exempt bond issue, the proceeds of which are used to purchase GNMA multifamily securities and thereby finance construction of an apartment development whose loan is insured by FHA. As shown in FIG. 4a, the process is begun at 130 by a borrower and FHA Lender/GNMA Issuer preparing an FHA insurance application 132. The FHA Lender/GNMA Issuer submits an FHA loan insurance application 134 to the FHA for approval 136. If not approved, the FHA loan application is returned to the FHA Lender/GNMA Issuer for correction. If approved, a bond issuer offers tax-exempt municipal bonds to fund the project 138. Prior to the tax-exempt bond issuer offering the municipal bonds, documentation for the tax-exempt bond issue is prepared by or for the bond issuer 140. The terms of a municipal bond issue are negotiated with the bond purchaser and the bond purchase agreement is executed 142. Cash in the amount equal to entire bond issue is provided 144 by the purchaser of the tax-exempt bonds. The bond purchaser pays for all the bonds at the bond closing 146. This causes the bond issuer, its trustee and the borrower to enter into a loan agreement 148. The trustee and the FHA Lender/GNMA Issuer enter into a purchase and sale agreement 150. The borrower and the FHA Lender/GNMA Issuer enter into an FHA mortgage agreement and note 156. The bond trustee then deposits any unspent bonds into an investment instrument 152. The investment instrument can produce negative arbitrage expense 154.

An alternative to the steps 148 and 150 is that the four parties involved in these steps, the issuer, borrower, bond trustee and GNMA issuer enter into a four party loan agreement.

This completes the process for the bond acquisition and the loan negotiation. Next is the periodic funding of the loan draws with the bond proceeds.

The borrower incurs a first set of development costs 158 after which the borrower submits a loan draw request to the FHA Lender/GNMA Issuer for the first loan draw 160. The FHA Lender/GNMA Issuer either approves the FHA loan draw request 162 after which the FHA Lender/GNMA Issuer prepares and submits the request for FHA insurance endorsement on the borrower's loan draw request 164. If the loan request is denied, it is returned to the borrower 160 for correction.

Turning now to FIG. 4b, the FHA approves the request for insurance endorsement of the loan draw 166 if the application is correct; otherwise the application is returned to the FHA Lender/GNMA Issuer for correction. After approval of the request for insurance by the FHA, the FHA Lender/GNMA Issuer updates the loan documentation to reflect the draw 168. After step 168, the FHA Lender/GNMA Issuer extends the loan funds to the borrower 169 so that the borrower can pay the development costs 170, while the FHA Lender/GNMA Issuer prepares a submission to the GNMA to authorize the issuance of the GNMA securities 171. If the GNMA approves the issuance of the GNMA securities related to the FHA endorsement of the first draw 173 then GNMA approval is obtained 175. After GNMA approval 175, the FHA Lender/GNMA Issuer delivers the GNMA securities to the bond trustee 172 and the bond trustee withdraws cash from the investment instrument sufficient to purchase the GNMA securities being delivered 174. The bond trustee pays cash to the FHA Lender/GNMA Issuer to purchase the GNMA securities associated with the first draw 176 which completes the first draw 178.

As the construction project continues, the borrower incurs a second set of development costs 180 after which the borrower submits a loan draw request for the second draw to the FHA Lender/GNMA Issuer 182. The process steps 158 to 178 described above are repeated for N cycles of loan draws 184.

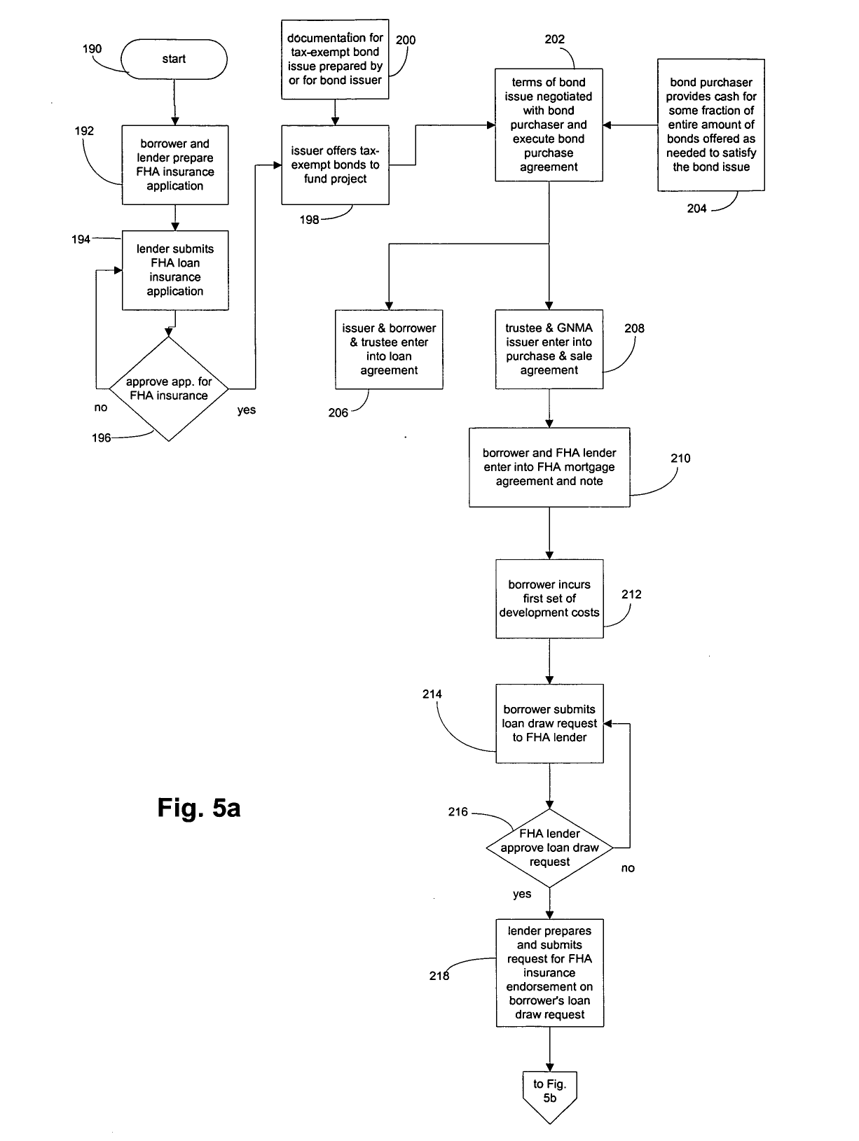

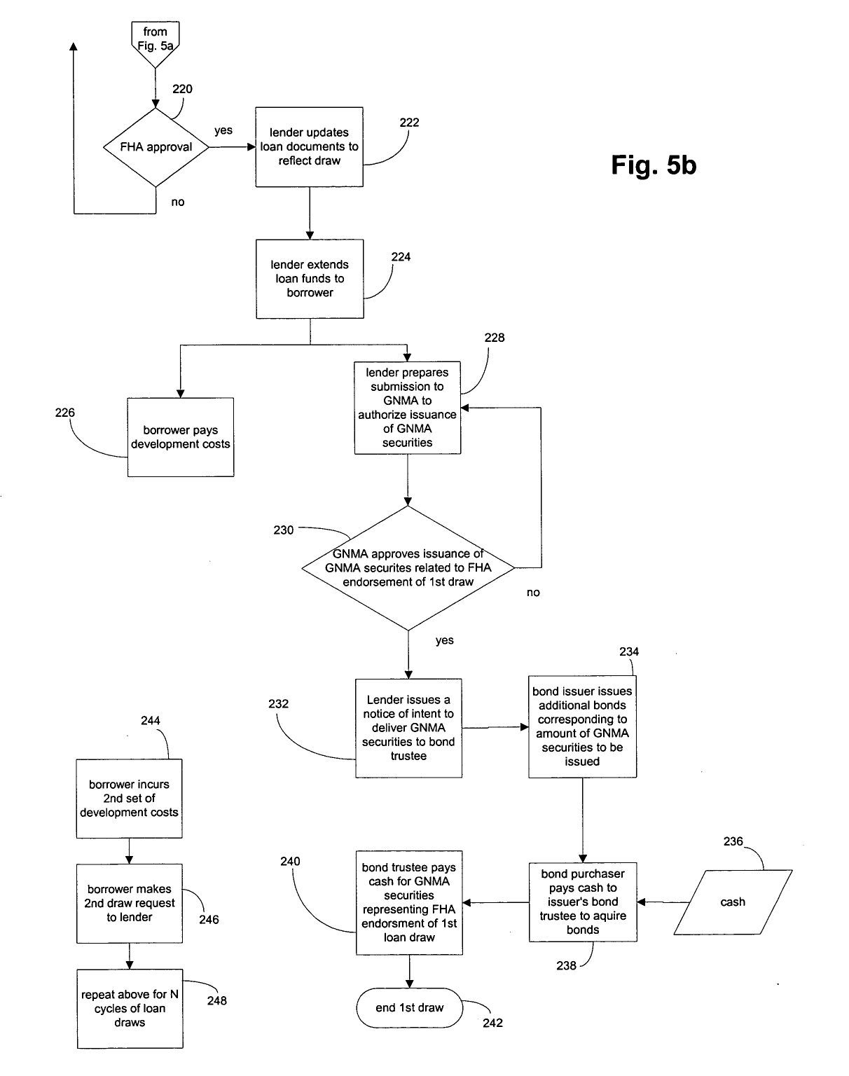

Turning now to FIGS. 5a and 5b, a process similar to that of FIGS. 4a and 4b is provided for an FHA insured loan funded by the sale of tax-exempt bonds, the proceeds of which are used to purchase GNMA securities. However, departing from the process of FIGS. 4a and 4b, the tax-exempt municipal bond issuer sells the municipal bonds on a drawdown or incremental forward-delivery basis. As shown in FIGS. 5a and 5b, the process similar to that of FIGS. 4a and 4b is performed with the exception that not all of the municipal bonds are issued and paid for at the initial closing, but instead only a fraction of the cash is provided by the bond purchaser for the tax-exempt bonds. In particular, the bond purchaser provides cash for that fraction of the entire amount of bonds offered as needed to satisfy the technical requirements to establish an initial closing date for a tax exempt bond issue. A further difference over the process of FIGS. 4a and 4b is the elimination of the steps where the bond trustee deposits the unspent bond proceeds in the investment instrument. The bond trustee also need not withdraw cash from the investment instrument sufficient to purchase the GNMA securities being delivered. Instead, additional bonds are issued as needed to provide the cash to purchase GNMA securities on dates and in the amounts as needed.

In particular, FIG. 5a starts the process at 190 and a borrower and FHA Lender/GNMA Issuer prepare an FHA insurance application 192. The FHA Lender/GNMA Issuer submits the FHA loan insurance application to the FHA 194 and if approved 196, then the municipal bond issuer offers the tax exempt bonds to fund the project 198. As input to the offer of the bonds at 198, the documents for the tax exempt bond issue are prepared by or for the municipal bond issuer 200.

Terms of an agreement on the municipal bond issue are negotiated with the bond purchaser and the bond purchase agreement is executed 202. Once the agreement 202 is in place, the bond purchaser provides cash for that fraction of the entire amount of the bonds offered as needed to satisfy the technical requirements to establish an initial closing date for a tax exempt bond issue 204. The municipal bond issuer, borrower and trustee enter into a loan agreement 206. The trustee and FHA Lender/GNMA Issuer enter into a purchase and sale agreement 208. With the purchase and sale agreement 208 in place, the borrower and FHA Lender/GNMA Issuer enter into an FHA mortgage agreement and note 210. These steps 202, 204, 206, 208 and 210 are interchangeable and generally happen over a relatively short period of time, within a week for example.

Construction on the new or redeveloping multifamily housing project begins and the borrower incurs the first set of development costs 212. The borrower submits a loan draw request to the FHA Lender/GNMA Issuer 214. If approved by the FHA Lender/GNMA Issuer 216, the lender prepares and submits the request for FHA insurance endorsement on the borrower's loan draw request 218. Otherwise, the FHA Lender/GNMA Issuer requires that the loan draw request be corrected and resubmitted.

Turning to FIG. 5b, the request for FHA approval is approved 220 which results in the FHA Lender/GNMA Issuer updating the loan documents to reflect the draw 222. As before, if not approved, the FHA application is required to be resubmitted. After the updating of the documents, the FHA Lender/GNMA Issuer extends the loan to the borrower 224. The borrower is then able to pay the development costs for this first draw 226. The FHA Lender/GNMA Issuer prepares the submission to GNMA to authorize the issuance of the GNMA securities 228. If the submission is prepared correctly, the GNMA approves the issuance of the GNMA securities related to the FHA endorsement of the first draw 230. If not, the submission is returned for correction.

After GNMA approval, the FHA Lender/GNMA Issuer gives notice of intent to deliver the GNMA securities to the bond trustee 232. Next, the bond issuer issues additional bonds corresponding to the amount of the GNMA securities to be purchased 234 and the bond purchaser pays cash 236 to the issuer's bond trustee to acquire the bonds 238. Then, the bond trustee pays cash for the GNMA securities representing the FHA endorsement of the first loan draw 240. This completes the first draw 242.

As construction on the multifamily construction or redevelopment progresses, additional costs are incurred. When they reach a level sufficient to trigger a second draw, the step 244 occurs. The borrower makes a second draw request to the lender 246 for finds to cover these costs. The series of steps 216 to 240 outlined above is carried out for this second draw, and for each subsequent draw for N cycles 248, until the all the bonds have been purchased by the bond purchaser.

Re-phrasing some of the steps in the process where the FHA Lender/GNMA Issuer issues the GNMA securities and the trustee purchases the securities, the GNMA approves the issuance of the GNMA securities after which the FHA Lender/GNMA Issuer provides a notice of intent to deliver the GNMA securities to the bond trustee. This results in the municipal bond issuer issuing incremental bonds in an amount corresponding to the amount of GNMA securities delivered (with rounding adjustments in increments of $1,000). The bond purchaser then pays cash to the trustee for the purchase of the incremental municipal bonds. The bond trustee, in turn, pays cash to purchase the GNMA securities associated with the first draw to complete the first draw portion of the process.

In one specific example, the process is carried out at follows:

1. A borrower enlists a tax-exempt entity to be the issuer of bonds and perform as the conduit for the capital to purchase GNMA securities.

2. Via the FHA lender/GNMA issuer, the borrower applies for and receives approval for FHA loan insurance.

3. A municipal bond issuer or the borrower assembles a team of financial and legal vendors to assist in assembling the loan and bond transaction, including a bond counsel and a bond placement agent/underwriter.

4. Transaction documentation is prepared that includes a loan agreement between the municipal bond issuer and the borrower and furthermore a bond indenture or bond resolution between the municipal bond issuer and a bond purchaser or purchasers. This transaction documentation must reflect that the bonds will be offered on a draw down basis in principal amounts corresponding to the amount of GNMA securities as delivered during the construction phase.

5. Municipal bonds are offered to investors on a draw down basis. Agreements with investors are arrived at and signed, committing the investor(s) to purchase the bonds when and in the amounts issued.

6. To comply with the federal tax laws related to the issuance of municipal bonds, the bonds are deemed issued when the first $50,000 of bonds are sold. Often it will be beneficial to issue $50,000 of bonds prior to any GNMA securities being available to establish a fixed stated closing date of the transaction for IRS purposes.

7. The borrower pursues the development of the project and incurs expenditures, all or a portion of which are eligible expenses for an FHA-insured loan.

8. Periodically (generally once each month), the borrower submits construction expenditure information to the FHA lender/GNMA issuer who arranges for each advance to be endorsed for insurance by FHA. Upon FHA insurance endorsement, the FHA Lender/GNMA Issuer then makes a loan advance to the borrower.

9. Following each FHA-insured loan advance, the FHA lender/GNMA issuer submits documentation to GNMA, which when approved, authorizes the FHA lender/GNMA issuer to issue GNMA securities.

10. The FHA Lender/GNMA Issuer notifies the municipal bond issuer's trustee that it is prepared to sell the GNMA securities to the bond trustee.

11. The municipal bond issuer prepares for an incremental issuance of bonds in a principal amount corresponding to the amount of GNMA securities to be delivered to the bond trustee.

12. The bond purchaser (or purchasers) remits funds to the issuer's bond trustee sufficient to pay for incremental issuance of municipal bonds.

13. The issuer's bond trustee applies the monies received from the bond purchaser to pay for the GNMA securities on their delivery date.

14. The bond trustee notifies the issuer and other relevant participants that additional bonds have been issued and that additional GNMA securities have been purchased.

Thus, there is provided a method to structure the sale of municipal bonds on an incremental draw-down basis when such bonds are used to purchase GNMA multifamily securities. According to the method, the proceeds from the sale of tax-exempt municipal bonds are used to purchase the GNMA securities, which tax-exempt bonds are sold on an incremental, forward-delivery basis for a period exceeding 90 days from the initial to the final issuance of the bonds. The bonds bear fixed interest rate. The result is a substantial reduction in the borrower's net financing costs.

The present invention provides a substantial reduction or elimination of the negative arbitrage costs when municipal bonds are issued to purchase GNMA multifamily securities. The purchaser of the bonds makes a forward commitment to purchase municipal bonds which will pay a pre-agreed fixed interest rate and which bonds will be issued, delivered and purchased on an incremental basis on dates and in amounts corresponding to when the GNMA multifamily securities are issued, delivered and available for purchase.

Although other modifications and changes may be suggested by those skilled in the art, it is the intention of the inventors to embody within the patent warranted hereon all changes and modifications as reasonably and properly come within the scope of their contribution to the art.

I claim:

1. A structure for a sale of municipal bonds, comprising:
an agreement between a municipal bond issuer and a bond purchaser for the bond purchaser to purchase tax exempt municipal bonds from the bond issuer from time-to-time in the future and at a predetermined interest rate, said agreement requiring said bond purchaser to purchase all bonds of a bond issue;
completion of at least one segment of approved expenditures in said development project sufficient to trigger a request for issuance of GNMA multifamily securities;
an approval for issuance of GNMA multifamily securities related to a portion of the loan for such multifamily housing development project;
a sale of a corresponding first portion of said municipal bonds to said bond purchaser at said predetermined interest rate;
an application of the proceeds of such municipal bond issue to purchase said GNMA multifamily securities;
completion of further segments of the approved expenditures in said development project sufficient to trigger issuance of further portions of said GNMA multifamily securities;
sale of corresponding further portions of said municipal bonds to said bond purchaser at said predetermined interest rate, wherein a final sale of said municipal bonds completes an obligation of said purchaser in accordance with said agreement; and
additional applications of the proceeds of such municipal bond issue to purchase such further portions of said GNMA multifamily securities.

2. A method for financing construction of a multiple family housing project, comprising the steps of:
enlisting a state or local government (or their housing authority, redevelopment authority or other body) to be the issuer of bonds and to make a loan to a project;
applying for approval for FHA loan insurance through an FHA approved lender;
obtaining a commitment from an investor to purchase bonds as delivered on a draw-down basis at a predetermined interest rate as such bonds may be issued from time to time;
proceeding with the construction project and incurring expenditures as eligible expenses of an FHA insured loan;
periodically submitting construction expenditures to the FHA lender so as to secure loan insurance endorsements from FHA;
obtaining approval of issuance of GNMA guaranteed securities corresponding to the FHA approved advances on the loan;
selling bonds to a bond purchaser in amounts so that the proceeds of such incremental issuance of bonds are sufficient for the municipal bond issuer (acting through its bond trustee) to purchase the GNMA securities as they are delivered; and
applying monies received by the bond trustee from the bond purchaser to pay for the GNMA securities.

3. A method as claimed in claim 1, wherein said municipal bond issuer acts through its bond trustee to purchase the GNMA securities.

4. A method as claimed in claim 2, wherein said state or local government is a tax exempt entity.

5. A system for issuing municipal bonds, comprising:
a FHA lender/GNMA issuer who makes a loan to a property developer and arranges for loan advances to be insured by FHA and guaranteed by GNMA so that the FHA lender/GNMA issuer is permitted to issue GNMA multifamily securities;
a borrower/property developer who uses the loan insured by FHA and guaranteed by GNMA to develop an apartment property;
an issuer of tax-exempt municipal bonds;
a purchaser of municipal bonds;
a bond trustee who is custodian of the proceeds of a sale of the municipal bonds and applies such proceeds to purchase of GNMA securities as the GNMA securities are made available by the FHA lender/GNMA issuer;
an agreement between the municipal bond issuer (or its trustee) and the purchaser of the municipal bonds for the purchase of the municipal bonds which will carry a pre-agreed fixed interest rate with such bonds issued in the future on an incremental basis at times and amounts corresponding to when the GNMA securities are delivered.
